(19) United States
(12) Patent Application Publication
(10) Pub. No.: US 2004/0174135 A1
(43) Pub. Date: Sep. 9, 2004

(54) Mobile power source

(76) Inventor: Robert Alex Durham, Peterborough (CA)

Correspondence Address: ROBERT A DURHAM, 537 ARMOUR RD, PETERBOURGH, K9H 1Y8, CA

(21) Appl. No.: 10/379,711

(22) Filed: Mar. 6, 2003

(51) Int. Cl. H02J 7/14

(52) U.S. Cl. 320/107

(57) ABSTRACT

In a machine for supplying electricity it is known to operate occasionally.

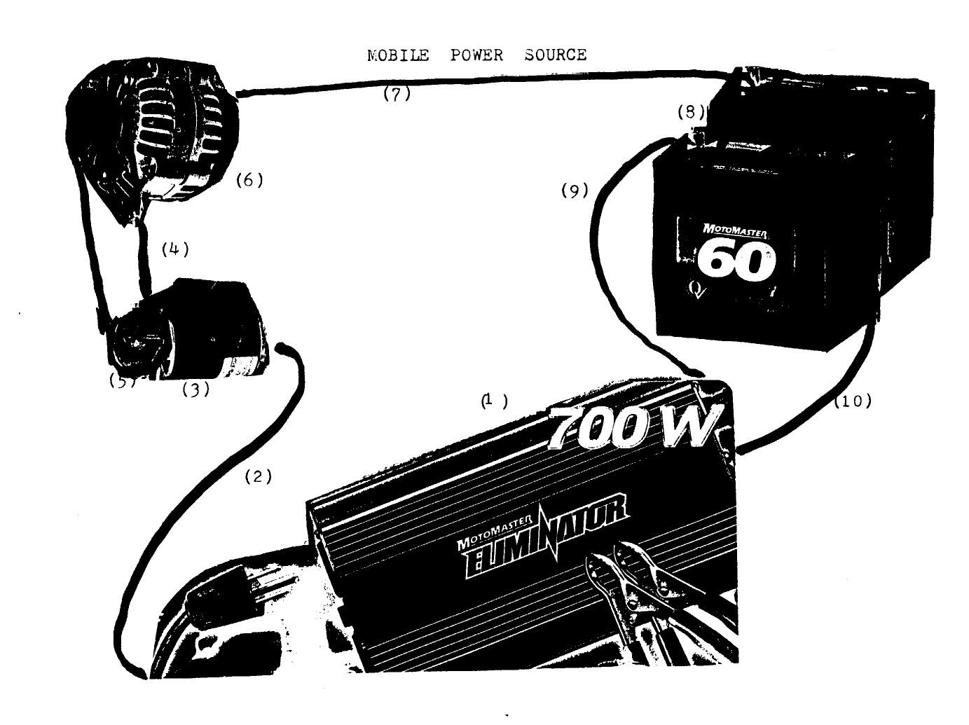

In this invention we have several parts that are all connected to each other.

The components that can be interchangeable would be the altinator or generator, both of which will accomplish the same results.

The batteries, electric motor, male plug and belt, Inverter with (2) or more female recepticals and an altinator are all in the equasion.

### DISCLOSURE

(!) This invention relates to an occasionally operating electrical producing machine.

(2) All other electrically producing machines have a different mode of propulsion.

(3) The new invention embodies the knowledge that anyone anywhere would be able to have electric power.

(4) When all set up together the area taken up is less than (2) feet square.

A small cage possibly with wheels could be developed to hold the unit.

### DESCRIPTION

### Mobile Power Source

Electrical power is a necessary commodity with to many uses to comment on.

Gas powered generators that pollute the air plus are very expensive to operate are one example. With this invention there is no polluted air and is very inexpensive to opert.

The batteries can be any number but must be wired in a 12 volt series.

To change the 12 volt DC battery power to 120 volts AC household electrical power an inverter is required with 2 female outlets. Equipped with a large pulley and a 2 foot extension cord with a male plug, the electric motor is a main player in the process. The male plug is placed into the inverter.

The alternator attached to the motor with a automotive belt will generate a charge for the batteries to complete a cycle.

To monitor the batteries we uses a voltage meter attached to the first and last batteries.

(1) INVERTER

(2) EXTENSION CORD

(3) ELECTRIC MOTOR

(4) AUTOMOTIVE BELT

(5) MOTOR PULLEY

(6) ALTERNATOR OR GENERATOR

(7) BATTERY CABLE

(8) BATTERIES

(9) and

(10) BATTERY CABLES

1. The embodiments of the invention in which an exclusive property or privilege is claimed are defined as follows:”
(a) in the case of an apparatus
(1) An electrically operable machine for occasional use.
(b) In the case of process
(1)A process for maintaining occasional electric power.
(c) In the case of an article
(1) The Mobile Power Source is the containment of seven or more individual properties combined together.
